(19) United States
(12) Patent Application Publication
(10) Pub. No.: US 2019/0370465 A1
(43) Pub. Date: Dec. 5, 2019

(54) Searchable Storage

(71) Applicant: Guobiao ZHANG, Corvallis, OR (US)

(72) Inventor: Guobiao ZHANG, Corvallis, OR (US)

(73) Assignee: HangZhou HaiCun Information Technology Co., Ltd., HangZhou (CN)

(21) Appl. No.: 16/543,554

(22) Filed: Aug. 17, 2019

Related U.S. Application Data
(63) Continuation-in-part of application No. 16/248,914, filed on Jan. 16, 2019.
Application No. 16/248,914 is a continuation-in-part of application No. 15/973,526, filed on May 7, 2018.
Application No. 15/973,526 is a continuation-in-part of application No. 15/452,728, filed on Mar. 7, 2017.

(30) Foreign Application Priority Data
Mar. 7, 2016 (CN) 201610127981.5
Mar. 3, 2017 (CN) 201710122861.0
Mar. 7, 2017 (CN) 201710130887.X
Apr. 26, 2018 (CN) 201810381860.2
Apr. 27, 2018 (CN) 201810388096.1
Jan. 13, 2019 (CN) 201910029515.7

(51) Int. Cl. G06F 21/56; G06F 16/903; G06F 13/40; G10L 15/22; G10L 15/18; G06K 9/62

(52) U.S. Cl. CPC G06F 21/564; G06F 16/90344; G06F 13/4027; G06F 2221/034; G10L 15/18; G06K 9/6215; G10L 15/22

(57) ABSTRACT

To achieve a better overall performance, a preferred pattern processor based on 3-D memory offsets large latency with massive parallelism. A searchable storage comprises a plurality of searchable 3-D memory dice, each of which has in-situ searching capabilities.

### CROSS-REFERENCE TO RELATED APPLICATIONS

This application is a continuation-in-part of application “Monolithic Three-Dimensional Pattern Processor”, application Ser. No. 16/248,914, filed Jan. 16, 2019, which is a continuation-in-part of application “Distributed Pattern Storage-Processing Circuit Comprising Three-Dimensional Vertical Memory Arrays”, application Ser. No. 15/973,526, filed May 7, 2018, which is a continuation-in-part of application “Distributed Pattern Processor Comprising Three-Dimensional Memory”, application Ser. No. 15/452,728, filed Mar. 7, 2017.

These applications claim priorities from Chinese Patent Application No. 201610127981.5, filed Mar. 7, 2016; Chinese Patent Application No. 201710122861.0, filed Mar. 3, 2017; Chinese Patent Application No. 201710130887.X, filed Mar. 7, 2017; Chinese Patent Application No. 201810381860.2, filed Apr. 26, 2018; Chinese Patent Application No. 201810388096.1, filed Apr. 27, 2018; Chinese Patent Application No. 201910029515.7, filed Jan. 13, 2019, in the State Intellectual Property Office of the People's Republic of China (CN), the disclosures of which are incorporated herein by references in their entireties.

### BACKGROUND

### 1. Technical Field of the Invention

The present invention relates to the field of integrated circuit, and more particularly to a searchable storage based on 3-D memory.

### 2. Prior Art

A pattern processor is a device for performing pattern processing. Pattern processing includes pattern matching and pattern recognition, which are the acts of searching a target pattern (i.e. the pattern to be searched, e.g. a network packet, a digital file) for the presence of the constituents or variants of a search pattern (i.e. the pattern used for searching, e.g. a virus pattern, a keyword). The match usually has to be “exact” for pattern matching, whereas it could be “likely to a certain degree” for pattern recognition. As used hereinafter, search patterns and target patterns are collectively referred to as patterns; a pattern database (also known as a pattern library) includes a plurality of related patterns, it could be a search-pattern database (also known as search-pattern library, e.g. a virus library, a keyword library) or a target-pattern database (also known as target-pattern library, e.g. a database or an archive).

Pattern processing has broad applications. Typical pattern processing includes code matching, string matching (also known as text matching, or keyword search), speech recognition and image recognition. Code matching is widely used in information security. Its operations include searching a virus pattern in a network packet or a digital file; or, checking if a network packet or a digital file conforms to a set of rules. String matching is widely used in big-data analytics. Its operations include searching a keyword in a digital file. Speech recognition identifies from the audio data the nearest acoustic/language model in an acoustic/language model library. Image recognition identifies from the image data the nearest image model in an image model library.

The pattern database has become large: the search-pattern library (e.g. a virus library, a keyword library, an acoustic/language model library, an image model library) is already big; while the target-pattern database (e.g. a collection of digital files, a big-data database/archive, an audio database/archive, an image database/archive) is even bigger. The conventional processor and its associated von Neumann architecture have great difficulties to perform fast pattern processing on large pattern databases.

U.S. Patent App. No. 2017/0061304 filed by Van Lunteren et al. discloses a three-dimensional (3-D) chip-based regular expression scanner (hereinafter Van Lunteren). It is a pattern processor module comprising an FPGA logic layer (i.e. an FPGA die), a fabric layer (i.e. a fabric die) and four memory array layers (i.e. four eDRAM dice). All four eDRAM dice are vertically linked together by inter-die connections, e.g. through-silicon vias (TSV's). Each eDRAM die contains 8*8=64 eDRAM clusters, with each eDRAM cluster containing 4*4=16 eDRAM blocks (also known as eDRAM arrays). Each eDRAM cluster and the associated FPGA segment form a storage-processing unit (SPU). This type of integration is generally referred to as 3-D packaging.

For the pattern processor module of Van Lunteren, an eDRAM die has a typical thickness of ˜50 micrometers. To penetrate through the eDRAM die, the TSV's have a typical size of ˜5 micrometers and a typical spacing of ˜10 micrometers. For the state-of-the-art eDRAM technology (currently at the ˜20 nanometer node), to accommodate enough inter-die connections between the FPGA die and the eDRAM dice, the TSV's would occupy significant silicon real estate. Adding the fact that each eDRAM cluster has a relatively large footprint, the pattern processor module offers a limited parallelism of 64, i.e. 64 SPU's are running in parallel.

The eDRAM in the pattern processor module is a volatile memory. Because its data will be lost once power goes off, the volatile memory cannot be used as a long-term data store. Data have to be stored elsewhere for long term, e.g. in an external storage (which is non-volatile, e.g. a storage card or a solid-state drive) (Van Lunteren, FIG. 4, [0050]). Hence, the Van Lunteren's system comprises a pattern processor module and an external storage. Because the pattern-processing throughput of the Van Lunteren's system is limited by the bandwidth between the external storage and the pattern processor module, the pattern-processing time (e.g. search time) for the whole external storage is proportional to its capacity. For a large storage capacity, the pattern-processing time ranges from minutes to hours, or even longer.

U.S. Patent App. No. 2004/0012053 filed by Zhang discloses a 3-D integrated memory (hereinafter Zhang), which is a monolithic die comprising 3-D memory (3D-M) arrays vertically integrated with an embedded processor. The 3D-M array(s) and the processor are communicatively coupled with intra-die connections, e.g. contact vias. This type of integration is generally referred to as 3-D integration. As its degree of parallelism is not specified (FIG. 2B of Zhang shows only a single SPU, equivalent to a parallelism of one), the 3-D integration of Zhang is referred to as simple 3-D integration.

The simple 3-D integration (Zhang) would have a poorer overall performance than the 3-D packaging (Van Lunteren) for the following reason. The active elements (i.e. memory cells) of the 3D-M array are made of non-single-crystalline (e.g. poly-crystalline) semiconductor material, i.e. they do not comprise any single-crystalline semiconductor material. On the other hand, the active elements (i.e. transistors) of the conventional two-dimensional (2-D) memory (e.g. SRAM, DRAM) are made of at least one single-crystalline semiconductor material. Because the poly-crystalline semiconductor material is inferior in performance to the single-crystalline semiconductor material, the 3D-M would have a larger latency than the conventional 2-D memory (e.g. SRAM, DRAM).

### Objects and Advantages

It is a principle object of the present invention to improve the overall performance of pattern processing for a large pattern database.

It is a principle object of the present invention to achieve a substantially higher throughput for pattern processing.

It is a further object of the present invention to offset the large latency of the 3-D non-volatile memory (3D-NVM) with massive parallelism.

It is a further object of the present invention to enhance information security.

It is a further object of the present invention to provide an anti-virus storage.

It is a further object of the present invention to improve the overall performance of big-data analytics.

It is a further object of the present invention to provide a searchable big-data storage.

It is a further object of the present invention to improve the overall performance of speech recognition

It is a further object of the present invention to provide a searchable audio storage.

It is a further object of the present invention to improve the overall performance of image recognition.

It is a further object of the present invention to provide a searchable image storage.

In accordance with these and other objects of the present invention, the present invention discloses a pattern processor and a searchable storage.

### SUMMARY OF THE INVENTION

Due to its low cost per gigabyte and its nature of long-term storage, it is desired to use a 3-D non-volatile memory (3D-NVM) (e.g. 3D-OTP, 3D-XPoint, 3D-NAND) to store patterns in a pattern processor. However, because the 3D-M has a larger latency than a conventional 2-D memory (e.g. SRAM, DRAM), adding the fact that a non-volatile memory (NVM) generally has a larger latency than a volatile memory (e.g. SRAM, DRAM), the pattern processor based on the 3D-NVM is expected to have a poorer performance than the pattern processor module of Van Lunteren.

The present invention reverses this expectation. Because the overall performance of a pattern processor is determined by not only latency, but also throughput (Performance=Throughput/Latency), the deficiency in latency can be remedied by throughput. Accordingly, the present invention discloses a pattern processor, which offsets large latency with massive parallelism. The preferred pattern processor is a monolithic die and comprises massive number of storage-processing units (SPU's). In one preferred embodiment, a pattern processor die comprises at least one thousand SPU's. In another preferred embodiment, a pattern processor die comprises at least ten thousand SPU's. Each SPU comprises at least a 3-D non-volatile memory (3D-NVM) array for storing at least a portion of a pattern and a pattern-processing circuit for processing the pattern. The pattern-processing circuit is disposed on a semiconductor substrate, with the 3D-NVM array vertically stacked thereupon. The 3D-NVM array and the pattern-processing circuit at least partially overlap. They are communicatively coupled by a larger number of intra-die connections. Because the SPU's perform pattern processing simultaneously, the preferred pattern processor supports massive parallelism.

Due to massive parallelism, this type of the 3-D integration is referred to as massive 3-D integration. The preferred pattern processor die comprises substantially more SPU's than the pattern processor module (Van Lunteren). For example, since a 128 gigabit 3D-XPoint die contains 64,000 3D-XPoint arrays, it can achieve a degree of parallelism of up to 64,000. This is substantially larger than the pattern processor module. Because a volatile memory array (e.g. an eDRAM array) has a much larger footprint than a 3D-NVM array, adding the fact that the TSV's occupy significant area, the SPU of the pattern processor module has a much larger footprint than the SPU of the preferred pattern processor die. As a result, the pattern processor module achieves a degree of parallelism of 64 (Van Lunteren, [0044]). Apparently, this difference in the degree of parallelism is large enough to compensate the difference in latency between 3D-XPoint and eDRAM. In general, the preferred pattern processor die contains at least ten times more SPU's.

Besides massive parallelism, the preferred pattern processor provides a large bandwidth between storage and processor. Because the intra-die connections (e.g. contact vias) between the 3D-NVM array and the pattern-processing circuit are short (typically around one micrometer long) and numerous (typically including at least one thousand contact vias in a single SPU; and, at least one million contact vias in a single die), the preferred pattern processor die can achieve a much larger bandwidth than the pattern processor module (Van Lunteren), whose inter-die connections (e.g. TSV's) are long (around one hundred micrometers long) and fewer (typically around one thousand TSV's in a single module).

Accordingly, the present invention discloses a pattern processor die, comprising a semiconductor substrate having transistors thereon; an input bus for transferring at least a first portion of a first pattern; at least one thousand storage-processing units (SPU's) disposed on said semiconductor substrate and communicatively coupled with said input bus, each of said SPU's comprising: a pattern-processing circuit made of single-crystalline semiconductor material, disposed on said semiconductor substrate; at least a 3-D non-volatile memory (3D-NVM) array made of non-single-crystalline semiconductor material, stacked above said pattern-processing circuit; a plurality of intra-die connections for communicatively coupling said 3D-NVM array and said pattern-processing circuit; wherein said 3D-NVM array stores at least a second portion of a second pattern; said pattern-processing circuit performs pattern processing for said first and second patterns. Preferably, the number of SPU's in said pattern processor die is substantially more than the number of SPU's in a pattern processor module.

The present invention further discloses a searchable storage. Similar to a conventional storage (comprising a plurality of flash memory dice), it comprises a plurality of pattern processor dice, which are storage-like. In the context of storage, a storage-like pattern processor die is referred to as a searchable 3-D memory die. The primary purpose of the preferred searchable storage is to store a target-pattern database (e.g. a collection of digital files, a big-data database/archive, an audio database/archive, an image database/archive), with a secondary purpose of searching the stored target-pattern database for a search pattern specified by a user. Each of the searchable 3-D memory dice stores at least a portion of data for the target-pattern database. More importantly, all of the searchable 3-D memory dice have in-situ searching capabilities. This is different from the conventional storage, where the flash memory dice are pure memory and do not have any in-situ searching capabilities.

In a preferred searchable 3-D memory die, because each SPU contains a pattern-processing circuit, the data stored in its 3D-NVM array(s) can be individually searched by the local pattern-processing circuit. No matter how large is the capacity of the target-pattern database, the search time for the whole database is similar to that for a single SPU. In other words, the search time for a target-pattern database is irrelevant to its capacity. Most searches can be completed within seconds. This is significantly faster than the conventional storage (e.g. the Van Lunteren's system).

This speed advantage can be further viewed from the perspective of parallelism. Because each SPU has its own pattern-processing circuit, the number of the SPU's grows with the storage capacity, so does the degree of parallelism. As a result, the search time does not increase with the storage capacity. However, for the pattern processor module, because the number of the SPU's and the degree of parallelism are fixed, the search time increases with the storage capacity.

Besides a substantial speed advantage, the preferred searchable storage provides a substantial cost advantage. With the 3-D integration, the peripheral circuits of the 3D-NVM arrays and the pattern-processing circuit can be formed on the substrate directly underneath the 3D-NVM arrays. Because the peripheral circuits of the 3D-NVM arrays only occupy a small portion of the substrate area, most substrate area can be used to form the pattern-processing circuits. As the peripheral circuits of the 3D-NVM arrays need to be formed anyway, the pattern-processing circuits can piggyback on the peripheral circuits, i.e. they can be manufactured at the same time with the peripheral circuits. Hence, inclusion of the pattern-processing circuits adds little or no extra cost to the preferred searchable storage. In prior art, inclusion of the pattern-processing circuits require an extra die (e.g. Van Lunteren) or an extra die area, both of which increase cost.

The preferred searchable storage provides with a substantial speed advantage (i.e. search time does not increase with capacity) and a substantial cost advantage (i.e. pattern processing does not incur extra cost). Accordingly, the present invention discloses a searchable storage comprising a plurality of searchable 3-D memory dice, each of said searchable 3-D memory dice comprising: a semiconductor substrate having transistors thereon; an input bus for transferring at least a search pattern; a plurality of storage-processing units (SPU's) disposed on said semiconductor substrate and communicatively coupled with said input bus, wherein each of said SPU's comprises: a pattern-processing circuit disposed on said semiconductor substrate; at least a 3-D non-volatile memory (3D-NVM) array stacked above said pattern-processing circuit; a plurality of intra-die connections for communicatively coupling said 3D-NVM array and said pattern-processing circuit; wherein said 3D-NVM array stores at least a portion of data; said pattern-processing circuit performs pattern processing for said search pattern and said portion of data; whereby the primary purpose of said searchable storage is long-term storage and the secondary purpose of said searchable storage is in-situ search.

Due to layout constraints, the pattern-processing circuit in the preferred searchable storage has limited functionalities. The preferred searchable storage preferably works with an external processor for full pattern processing. Accordingly, the present invention discloses a storage system comprising a searchable storage and a standalone processor. The standalone processor could be a full-power processor which can perform full pattern processing. It could be a CPU, a GPU, an FPGA, an Al processor, or others. The pattern-processing circuit in the preferred searchable storage performs preliminary pattern processing. After this preliminary pattern-processing step, data are output to the standalone processor to perform full pattern processing. Because the amount of the data output from the preferred searchable storage is substantially smaller than the amount of the data stored in the preferred searchable storage, the data transfer places less burden on the system bus between the searchable storage and the standalone processor. With much less data to process, the full pattern processing, even for the full searchable storage, takes less time and becomes more efficient.

Accordingly, the present invention discloses a storage system, comprising a standalone processor and a searchable storage, wherein said searchable storage comprises a plurality of searchable 3-D memory dice, each of said searchable 3-D memory dice comprising: a semiconductor substrate having transistors thereon; an input bus for transferring at least a search pattern; an output bus communicatively coupled with said standalone processor; a plurality of storage-processing units (SPU's) disposed on said semiconductor substrate and communicatively coupled with said input bus and said output bus, wherein each of said SPU's comprises: a pattern-processing circuit disposed on said semiconductor substrate; at least a 3-D non-volatile memory (3D-NVM) array stacked above said pattern-processing circuit; a plurality of intra-die connections for communicatively coupling said 3D-NVM array and said pattern-processing circuit; wherein said 3D-NVM array stores at least a portion of data; said pattern-processing circuit performs preliminary pattern processing for said search pattern and said portion of data; whereby a fraction of said portion of data is transferred via said output bus to said standalone processor; and, said standalone processor performs full pattern processing on said fraction of said portion of data.

### BRIEF DESCRIPTION OF THE DRAWINGS

FIG. 1A is a circuit block diagram of a preferred pattern-processor die; FIG. 1B is a circuit block diagram of a preferred storage-processing unit (SPU);

FIGS. 2A-2D are cross-sectional views of four preferred SPU's;

FIG. 3 is a perspective view of a preferred SPU;

FIGS. 4A-4C are circuit block diagrams of three preferred SPU's;

FIGS. 5A-5C are circuit layout views of three preferred SPU's on the substrate;

FIG. 6A is a perspective view of a preferred searchable storage; FIG. 6B is its circuit block diagram; FIG. 6C is a circuit block diagram of a preferred storage system.

It should be noted that all the drawings are schematic and not drawn to scale. Relative dimensions and proportions of parts of the device structures in the figures have been shown exaggerated or reduced in size for the sake of clarity and convenience in the drawings. The same reference symbols are generally used to refer to corresponding or similar features in the different embodiments.

As used herein, the phrase “memory” is used to mean a semiconductor memory die or semiconductor memory dice. The phrase “storage” is used in its broadest sense to mean any long-term information store. In this specification, the storage is a solid-state storage which comprises a plurality of non-volatile memory (NVM) dice. The phrase “memory array” is used in its broadest sense to mean a collection of all memory cells sharing at least an address line.

As used herein, the phrase “a circuit on a substrate” is used in its broadest sense to mean that at least some of its active elements or portions thereof (e.g. channel portion of the MOS transistor) are disposed in the substrate, even though the interconnects coupling them and/or some other active elements are disposed above the substrate. The phrase “a circuit above a substrate” is used in its broadest sense to mean that all active elements are disposed above the substrate, not in the substrate.

As used herein, the phrase “a circuit made of single-crystalline semiconductor material” means that a key portion (e.g. channel portion) of its active elements (e.g. transistors, memory cells) is formed in a single-crystalline semiconductor material. The phrase “a circuit made of non-single-crystalline (e.g. poly-crystalline) semiconductor material” means that a key portion (e.g. channel portion) of its active elements (e.g. transistors, memory cells) is formed in a non-single-crystalline (e.g. poly-crystalline) semiconductor material.

As used herein, the phrases “performing pattern processing for a search pattern and a target pattern”, “performing pattern processing for a pattern (e.g. a search pattern, a target pattern, or both)”, “searching a target pattern for a search pattern”, “searching a search pattern in a target pattern”, and “performing pattern recognition on a target pattern with a search pattern (or, a model)”, all have the same meaning. They are used in their broadest sense to mean pattern matching or pattern recognition between a search pattern and a target pattern.

As used herein, the phrases “diode”, “steering element”, “steering device”, “selector”, “selecting element”, “selecting device”, “selection element” and “selection device”, all have the same meaning. They are used in their broadest sense to mean a device whose resistance at the read voltage is substantially lower than when the applied voltage has a magnitude smaller than or polarity opposite to that of the read voltage.

As used herein, the phrase “communicatively coupled” is used in its broadest sense to mean any coupling whereby electrical signals may be passed from one element to another element. The phrase “pattern” could refer to either pattern per se, or the data related to a pattern, depending on the context. The phrase “image” is used in its broadest sense to mean still pictures and/or motion pictures. The phrase “database” and “library” are used interchangeably. The phrase “string-matching” and “text-matching” are used interchangeably. The symbol “/” means the relationship of “and” or “or”.

### DETAILED DESCRIPTION OF THE PREFERRED EMBODIMENTS

Those of ordinary skills in the art will realize that the following description of the present invention is illustrative only and is not intended to be in any way limiting. Other embodiments of the invention will readily suggest themselves to such skilled persons from an examination of the within disclosure.

To offset the large latency of the 3-D non-volatile memory (3D-NVM) with massive parallelism, the present invention discloses a pattern processor. It is a monolithic die and comprises massive number of storage-processing units (SPU's). Because the SPU's perform pattern processing simultaneously, the preferred pattern processor supports massive parallelism.

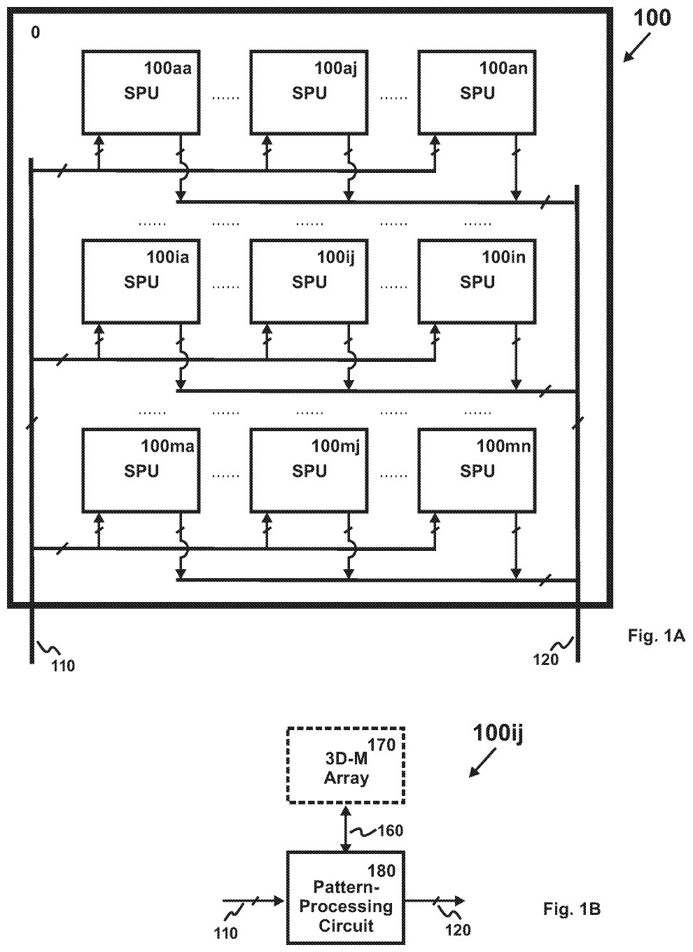

Referring now to FIGS. 1A-1B, an overview of a preferred pattern processor die 100 is disclosed. The preferred pattern processor die 100 is a monolithic die, which is disposed on a single semiconductor substrate 0. FIG. 1A is its circuit block diagram. The preferred pattern-processor die 100 not only processes patterns, but also stores patterns. It comprises an array with m rows and n columns (mxn) of storage-processing units (SPU's) 100aa-100mn. In one preferred embodiment, the preferred pattern-processor die 100 comprises at least one thousand SPU's 100aa-100mn. In another preferred embodiment, the preferred pattern-processor die 100 comprises at least ten thousand SPU's 100aa-100mn.

The preferred pattern processor die 100 has an input bus 110 and an output bus 120. The input bus 110 is communicatively coupled with the input buses of the SPU's 100aa-100mn, whereas the output bus 120 is communicatively coupled with the output buses of the SPU's 100aa-100mn. During pattern processing, an input pattern is sent via the input bus 110 to the SPU's 100aa-100mn. Because the SPU's 100aa-100mn process the input pattern simultaneously, the preferred pattern-processor die 100 can achieve a parallelism of mxn. After pattern processing, the outputs from the SPU's 100aa-100mn are sent out via the output bus 120.

The preferred pattern processor die 100 comprises substantially more SPU's 100aa-100mn than the pattern processor module (Van Lunteren). For example, since a 128 gigabit 3D-XPoint die contains 64,000 3D-XPoint arrays, it can achieve a degree of parallelism of up to 64,000. This is substantially larger than the pattern processor module. Because a volatile memory array (e.g. an eDRAM array) has a much larger footprint than a 3D-NVM array, adding the fact that the TSV's occupy significant area, the SPU of the pattern processor module has a much larger footprint than the SPU of the preferred pattern processor die 100. As a result, the pattern processor module achieves a degree of parallelism of 64 (Van Lunteren, [0044]). Apparently, this difference in the degree of parallelism is large enough to compensate the difference in latency between 3D-XPoint and eDRAM. In general, the preferred pattern processor die contains at least ten times more SPU's.

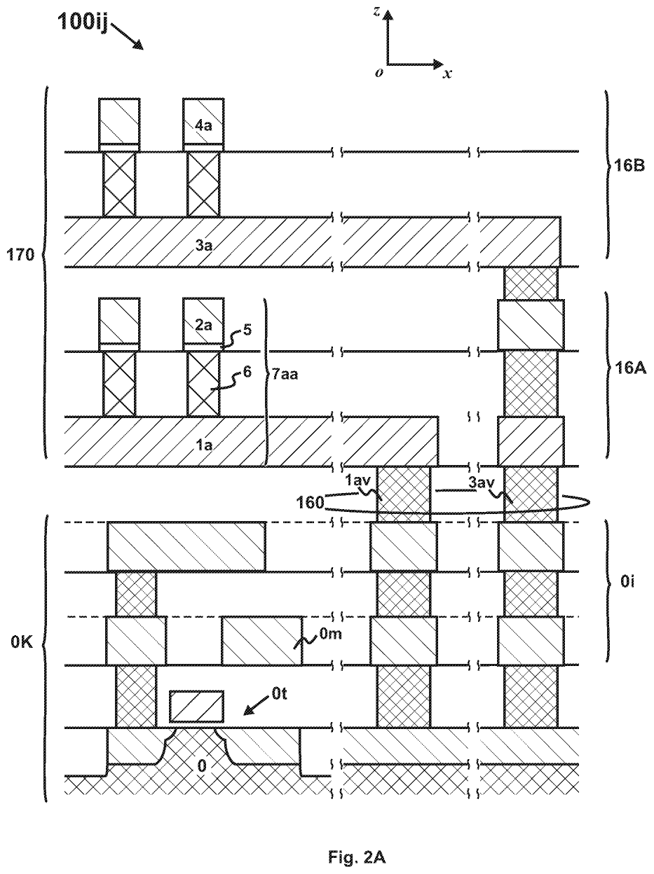

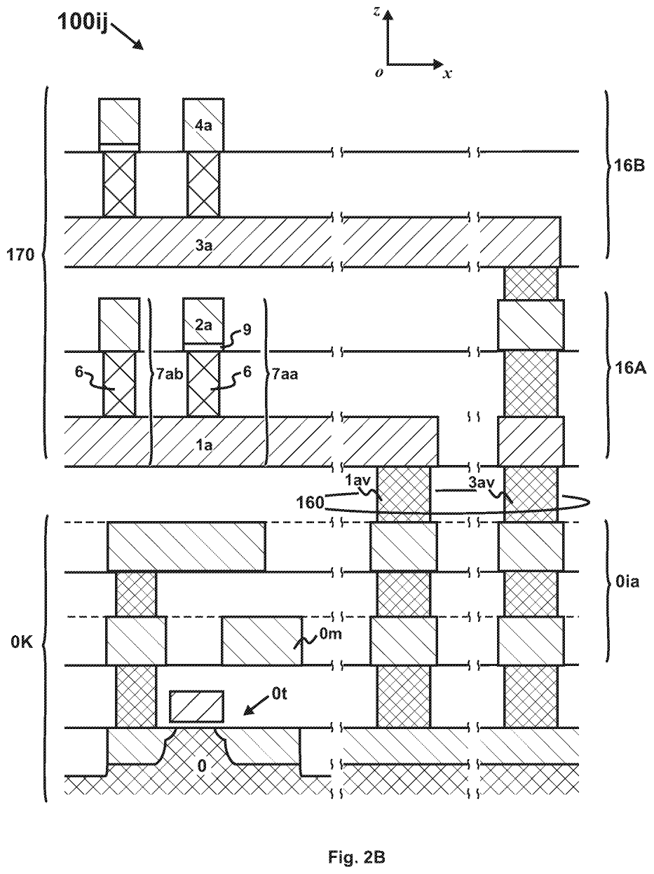

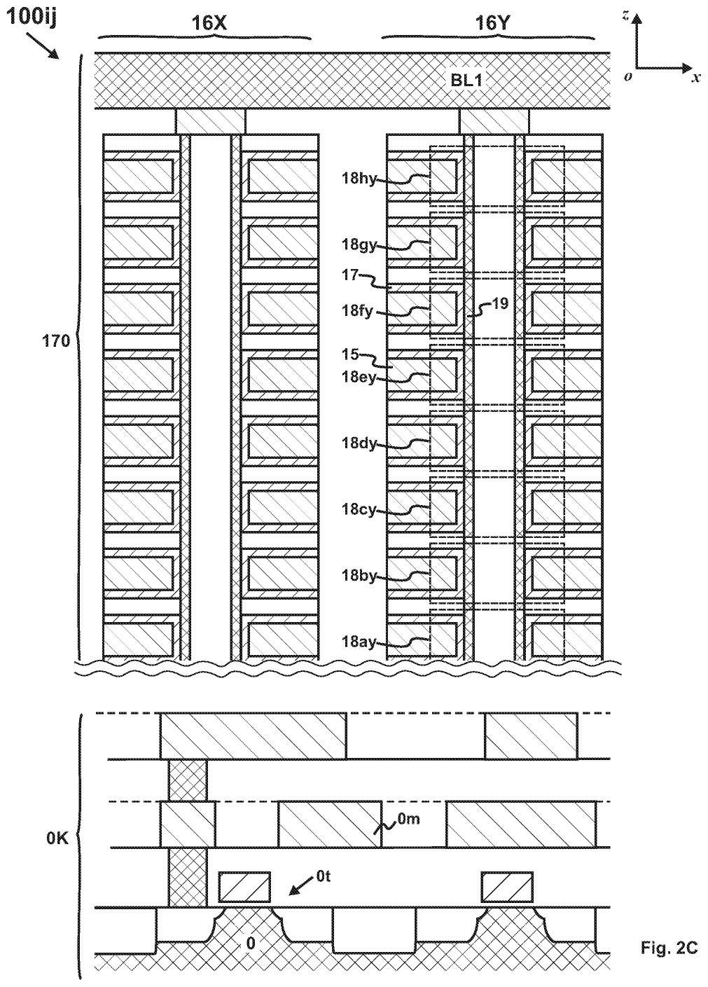

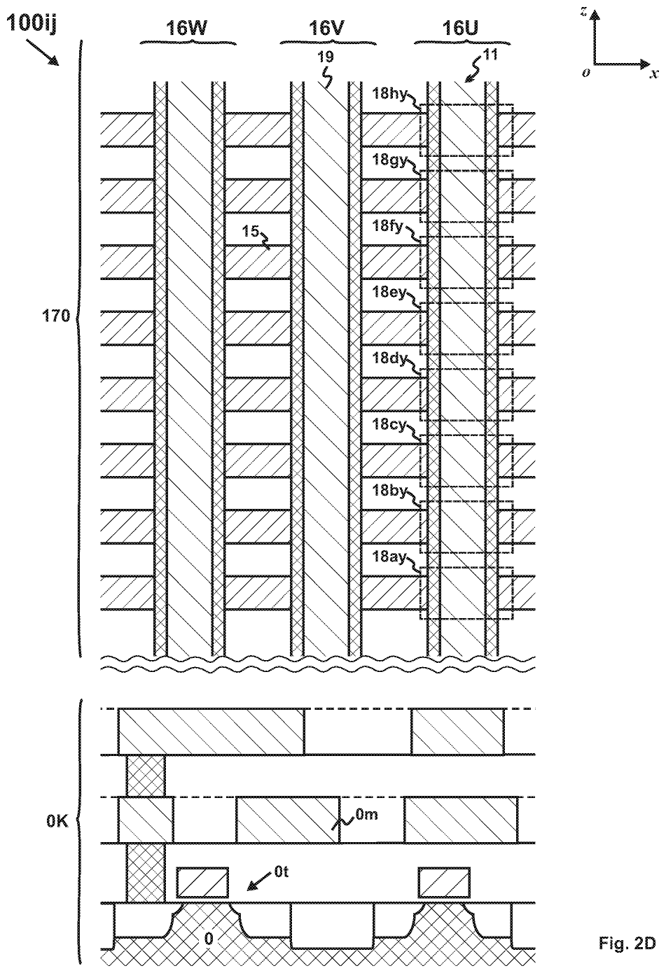

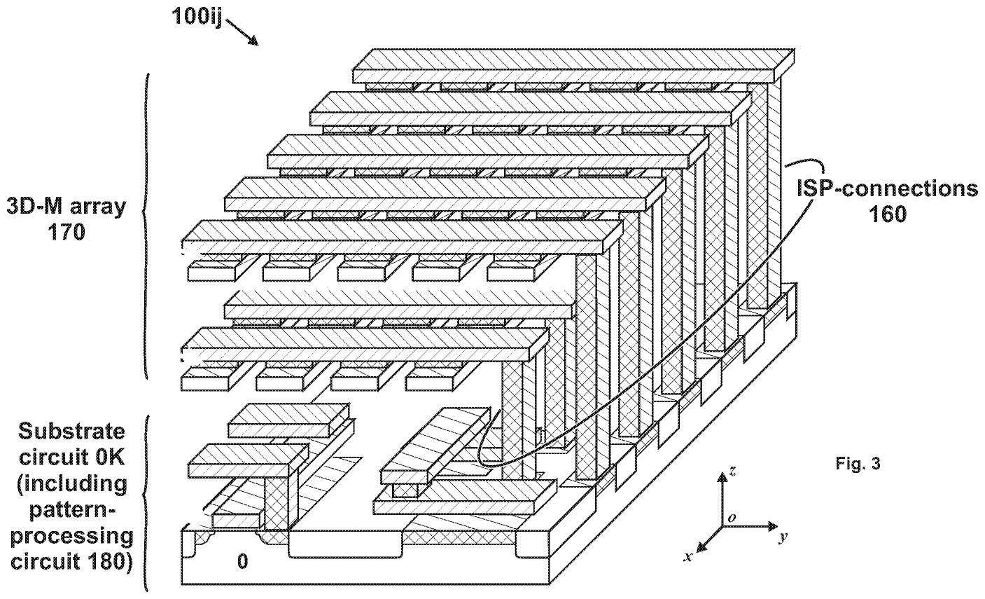

FIG. 1B is a circuit block diagram of a preferred SPU 100ij. The SPU 100ij comprises a pattern-storage circuit 170 and a pattern-processing circuit 180, which are communicatively coupled by the intra-die connections 160 (referring to FIGS. 2A-2B and FIG. 3). The pattern-storage circuit 170 comprises at least a 3D-NVM array. The 3D-NVM array 170 stores at least a portion of a pattern, whereas the pattern-processing circuit 180 processes the pattern. Because the 3D-NVM array 170 is located on a different physical level than the pattern-processing circuit 180 (referring to FIGS. 2A-2D and FIG. 3), the 3D-NVM array 170 is drawn by dashed lines.

The preferred pattern-processing circuit 180 could be a code-matching circuit, a string-matching circuit, a speech-recognition circuit, or an image-recognition circuit. These preferred pattern-processing circuits 180 are well known to those skilled in the art. For example, the code-matching circuit or the string-matching circuit could be implemented by a content-addressable memory (CAM) or a comparator (including XOR circuits, or a distance computing unit). Alternatively, a search pattern (e.g. keyword) can be represented by a regular expression. In this case, the string-matching circuit 180 can be implemented by a finite-state automata (FSA) circuit. Compared with the speech-recognition circuit or the image-recognition circuit, the code-matching circuit and the string-matching circuit are easier to design, smaller in footprint, and can be more easily placed underneath few 3D-NVM array(s) (e.g. fewer than four 3D-NVM arrays). With each SPU containing few 3D-NVM array(s), it would be easier to achieve a large degree of parallelism.

More details on the pattern-processing circuits are disclosed in U.S. Pat. No. 4,672,678 issued to Koezuka et al. on jun. 9, 1987; U.S. Pat. No. 4,985,863 issued to Fujisawa et al. on jan. 15, 1991; U.S. Pat. No. 5,140,644 issued to Kawaguchi et al. on Aug. 18, 1992; U.S. Pat. No. 5,276,741 issued to Aragon et al. on jan. 4, 1994; U.S. Pat. No. 5,579,411 issued to Shou et al. on Nov. 26, 1996; U.S. Pat. No. 5,671,292 issued to Lee et al. on Sep. 23, 1997; U.S. Pat. No. 7,487,542 issued to Boulanger et al. on Feb. 3, 2009; U.S. Pat. No. 8,717,218 issued to jhang et al. on May 6, 2014; U.S. Patent App. No. 2017/0061304 filed by Van Lunteren et al. on Sep. 1, 2015; and others.

Referring now to FIGS. 2A-2D, four preferred SPU's 100ij are shown. The preferred SPU 100ij uses monolithic integration per se, i.e. the memory cells are vertically stacked without any semiconductor substrate therebetween. The preferred 3D-M array in the present invention is a non-volatile memory (NVM), i.e. the data stored therein can be kept for a long term even when power goes off. The NVM (e.g. 3D-NVM) generally has a larger capacity and a lower cost than the volatile memory (e.g. SRAM, DRAM). As disclosed before, even though the 3D-NVM array has a larger latency, the present invention remedies this deficiency by employing massive parallelism to achieve a higher throughput.

Based on its physical structure, the 3D-NVM can be categorized into horizontal 3D-NVM (3D-NVM_{H}) and vertical 3D-NVM (3D-NVM_{V}). In a 3D-NVM_{H}, all address lines are horizontal. The memory cells form a plurality of horizontal memory levels which are vertically stacked above each other. A well-known 3D-NVM_{H} is 3D-XPoint. In a 3D-NVM_{V}, at least one set of the address lines are vertical. The memory cells form a plurality of vertical memory strings which are placed side-by-side on/above the substrate. A well-known 3D-NVM_{V} is 3D-NAND. In general, the 3D-NVM_{H} (e.g. 3D-XPoint) is faster, while the 3D-NVM_{V} (e.g. 3D-NAND) is denser.

Based on the programming methods, the 3D-NVM can be categorized into 3-D writable memory (3D-W) and 3-D printed memory (3D-P). The 3D-W cells are electrically programmable. Based on the number of programmings allowed, the 3D-W can be further categorized into three-dimensional one-time-programmable memory (3D-OTP) and three-dimensional multiple-time-programmable memory (3D-MTP, including re-programmable). Common 3D-MTP includes 3D-XPoint and 3D-NAND. Other 3D-MTP's include memristor, resistive random-access memory (RRAM or ReRAM), phase-change memory (PCM), programmable metallization cell (PMC) memory, conductive-bridging random-access memory (CBRAM), and the like.

For the 3D-P, data are recorded into the 3D-P cells using a printing method during manufacturing. These data are fixedly recorded and cannot be changed after manufacturing. The printing methods include photo-lithography, nano-imprint, e-beam lithography, DUV lithography, and laser-programming, etc. An exemplary 3D-P is three-dimensional mask-programmed read-only memory (3D-MPROM), whose data are recorded by photo-lithography. Because a 3D-P cell does not require electrical programming and can be biased at a larger voltage during read than the 3D-W cell, the 3D-P is faster.

In FIGS. 2A-2B, the preferred pattern processor die 100 comprises a substrate circuit OK and a 3D-NVM_{H} array 170 vertically stacked thereon. The substrate circuit OK includes transistors 0t and metal lines 0m. The transistors 0t are disposed on a semiconductor substrate 0. The metal lines 0m form substrate interconnects 0i, which communicatively couple the transistors 0t. The 3D-NVM_{H} array 170 includes two memory levels 16A, 16B, with the memory level 16A stacked on the substrate circuit OK and the memory level 16B stacked on the memory level 16A. Memory cells (e.g. 7aa) are disposed at the intersections between two address lines (e.g. 1a, 2a). At present, the width of the address lines (e.g. 1a, 2a) is typically smaller than one hundred nanometers (<100 nm). The memory levels 16A, 16B are communicatively coupled with the substrate circuit OK through contact vias 1av, 3av, which form the intra-die connections 160. The contact vias 1av, 3av comprise a plurality of vias, each of which is communicatively coupled with the vias above and below. The size of the contact vias (e.g. 1av, 3av) is preferably comparable to the width of the address lines (e.g. 1a, 2a). For example, the size of the contact vias could be twice or thrice as much as the width of the address lines. At present, the size of the contact vias (e.g. 1av, 3av) is typically smaller than one hundred nanometers (<100 nm). Apparently, the intra-die connections 160 do not penetrate the semiconductor substrate 0.

The 3D-NVM_{H} arrays 170 in FIG. 2A are 3D-W arrays. Its memory cell 7aa comprises a programmable layer 5 and a diode (also known as selector or other names) layer 6. The programmable layer 5 could be an antifuse layer (which can be programmed once and used for the 3D-OTP); or, a resistive RAM (RRAM) layer or phase-change material (PCM) layer (which can be re-programmed and used for the 3D-MTP). The diode layer 6 is broadly interpreted as any layer whose resistance at the read voltage is substantially lower than when the applied voltage has a magnitude smaller than or polarity opposite to that of the read voltage. The diode could be a semiconductor diode (e.g. p-i-n silicon diode), or a metal-oxide (e.g. TiO₂) diode.

The 3D-NVM_{H} arrays 170 in FIG. 2B are 3D-P arrays. It has at least two types of memory cells: a high-resistance memory cell 7aa, and a low-resistance memory cell 7ac. The low-resistance memory cell 7ac comprises a diode layer 6, which is similar to that in the 3D-W; whereas, the high-resistance memory cell 5aa comprises at least a high-resistance layer 9, which could simply be a layer of insulating dielectric (e.g. silicon oxide, or silicon nitride). It can be physically removed at the location of the low-resistance memory cell 7ac during manufacturing.

In FIGS. 2C-2D, the preferred pattern processor die 100 comprises a substrate circuit OK and a plurality of 3D-NVM_{V} arrays 170 vertically stacked thereon. The substrate circuit OK is similar to those in FIGS. 2A-2B. The 3D-NVM_{V} array 170 comprises a plurality of vertically stacked horizontal address lines 15. The 3D-NVM_{V} array 170 also comprises a set of vertical address lines, which are perpendicular to the surface of the substrate 0. The 3D-NVM_{V} has the largest storage density among semiconductor memories. For reason of simplicity, the intra-die connections (e.g. contact vias) 160 between the 3D-NVM_{V} arrays 170 and the substrate circuit OK are not shown. They are similar to those in the 3D-NVM_{H} arrays 170 and well known to those skilled in the art.

The preferred 3D-NVM_{V} array 170 in FIG. 2C is based on vertical transistors or transistor-like devices. It comprises a plurality of vertical memory strings 16X, 16Y placed side-by-side. Each memory string (e.g. 16Y) comprises a plurality of vertically stacked memory cells (e.g. 18ay-18hy). Each memory cell (e.g. 18fy) comprises a vertical transistor, which includes a gate (acts as a horizontal address line) 15, a storage layer 17, and a vertical channel (acts as a vertical address line) 19. The storage layer 17 could comprise oxide-nitride-oxide layers, oxide-poly silicon-oxide layers, or the like. This preferred 3D-NVM_{V} array 170 is a 3D-NAND and its manufacturing details are well known to those skilled in the art.

The preferred 3D-NVM_{V} array 170 in FIG. 2D is based on vertical diodes or diode-like devices. In this preferred embodiment, the 3D-NVM_{V} array comprises a plurality of vertical memory strings 16U-16 W placed side-by-side. Each memory string (e.g. 16U) comprises a plurality of vertically stacked memory cells (e.g. 18au-18hu). The 3D-NVM_{V} array 170 comprises a plurality of horizontal address lines (e.g. word lines) 15 which are vertically stacked above each other. After etching through the horizontal address lines 15 to form a plurality of vertical memory wells 11, the sidewalls of the memory wells 11 are covered with a programmable layer 13. The memory wells 11 are then filled with a conductive materials to form vertical address lines (e.g. bit lines) 19. The conductive materials could comprise metallic materials or doped semiconductor materials. The memory cells 18au-18hu are formed at the intersections of the word lines 15 and the bit line 19. The programmable layer 13 could be one-time-programmable (OTP, e.g. an antifuse layer) or multiple-time-programmable (MTP, e.g. an RRAM layer).

To minimize interference between memory cells, a diode (also known as selector or other names) is preferably formed between the word line 15 and the bit line 19. In a first embodiment, this diode is the programmable layer 13 per se, which could have an electrical characteristic of a diode. In a second embodiment, this diode is formed by depositing an extra diode layer on the sidewall of the memory well (not shown in this figure). In a third embodiment, this diode is formed naturally between the word line 15 and the bit line 19, i.e. to form a built-in junction (e.g. P-N junction, or Schottky junction). More details on the built-in diode are disclosed in U.S. patent application Ser. No. 16/137,512, filed on Sep. 20, 2018.

Referring now to FIG. 3, a perspective view of a preferred SPU 100ij is shown. The 3D-NVM array 170 storing patterns are vertically stacked above the substrate circuit OK. The substrate circuit OK includes the pattern-processing circuit 180 and is at least partially covered by the 3D-NVM array 170. The 3D-NVM array 170 and the substrate circuit OK are communicatively coupled through a plurality of intra-die connections (e.g. contact vias) 160. For reason of simplicity, only a 3D-NVM_{H} array 170 is shown in this figure.

In the preferred pattern processor 100, the size of the contact vias (e.g. 1av, 3av) is preferably comparable to the width of the address lines (e.g. 1a, 2a). Because the intra-die connections 160 (e.g. contact vias) are short (typically around one micrometer long) and numerous (typically including at least one thousand contact vias in a single SPU 100ij; and, at least one million contact vias in a single die 100), the preferred pattern processor die 100 can achieve a much larger bandwidth (between 3D-NVM array 170 and pattern-processing circuit 180) than the pattern processor module (Van Lunteren), whose inter-die connections (e.g. TSV's) are long (around one hundred micrometers long) and fewer (typically around one thousand TSV's in a single module).

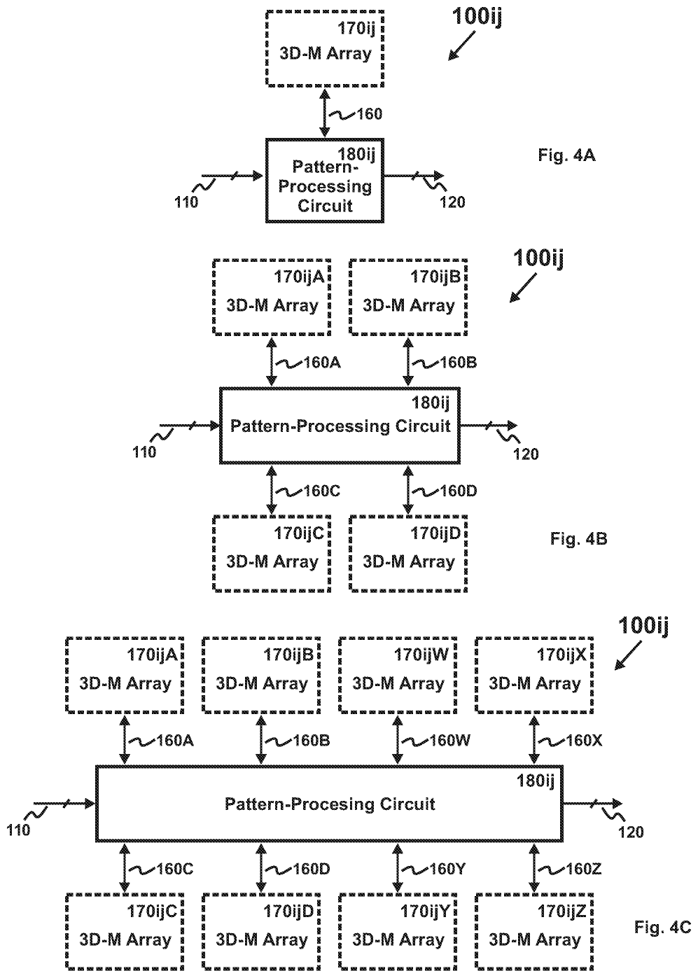

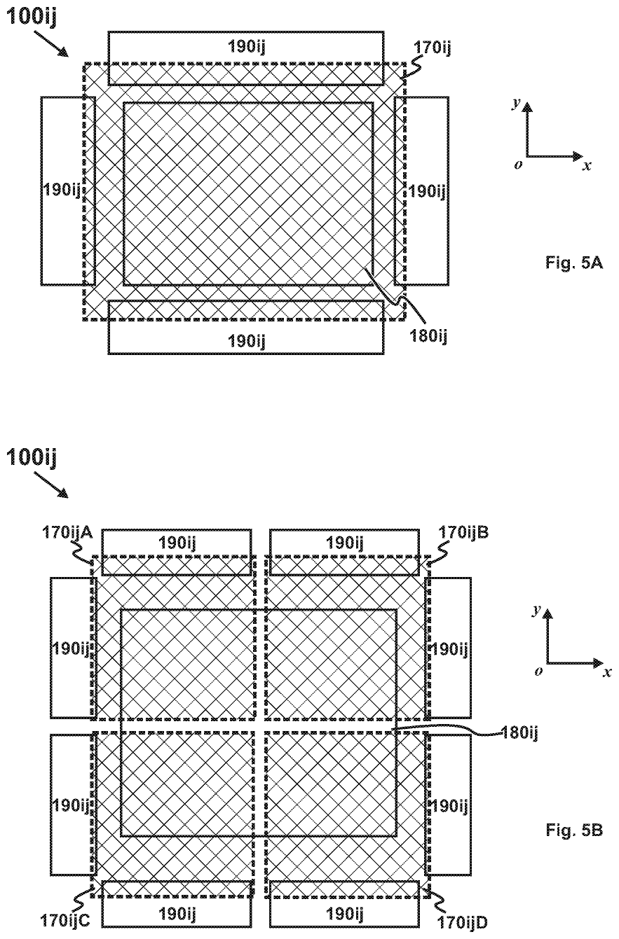

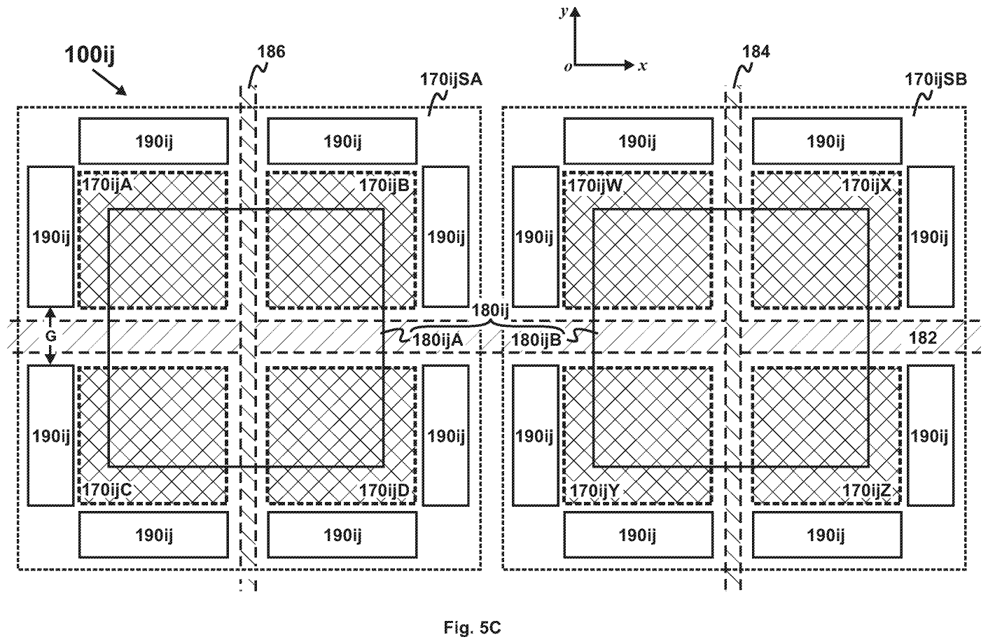

Referring now to FIGS. 4A-5C, three preferred SPU's 100ij are shown. FIGS. 4A-5C are their circuit block diagrams and FIGS. 5A-5C are their circuit layout views. In these preferred embodiments, a pattern-processing circuit 180ij serves different number of 3D-NVM arrays.

In FIG. 4A, each SPU 100ij comprises a single 3D-NVM array 170ij and therefore, the pattern-processing circuit 180ij serves this single 3D-NVM array 170ij, i.e. it processes the patterns stored in the 3D-NVM array 170ij. In FIG. 4B, each SPU 100ij comprises four 3D-NVM arrays 170ijA-100ijD and therefore, the pattern-processing circuit 180ij serves four 3D-NVM arrays 170ijA-170ijD, i.e. it processes the patterns stored in four 3D-NVM arrays 170ijA-170ijD. In FIG. 4C, each SPU 100ij comprises eight 3D-NVM arrays 170ijA-100ijD, 170ijW-170ijZ and therefore, the pattern-processing circuit 180ij serves eight 3D-NVM arrays 170ijA-170ijD, 170ijW-170ijZ, i.e. it processes the patterns stored in the 3D-NVM arrays 170ijA-170ijD, 170ijW-170ijZ. Because they are located on a different physical level than the pattern-processing circuit 180ij (referring to FIGS. 2A-2D), the 3D-NVM arrays 170ij-170ijZ are drawn by dashed lines.

FIGS. 5A-5C disclose the circuit layouts of the pattern-processing circuits 180, as well as the projections of the 3D-NVM arrays 170 on the substrate 0 (drawn by dashed lines). The embodiment of FIG. 5A corresponds to that of FIG. 4A. In this preferred embodiment, the pattern-processing circuit 180ij and the peripheral circuit 190ij of the 3D-NVM array 170ij are disposed on the substrate 0. They are at least partially covered by the 3D-NVM array 170ij. Because it is located under a single 3D-NVM array 170ij and has a relatively small footprint, this preferred pattern-processing circuit 180ij is best for a code-matching circuit or a string-matching circuit. With each SPU 100ij containing a single 3D-M array 170ij, this preferred embodiment ensures massive parallelism.

The embodiment of FIG. 5B corresponds to that of FIG. 4B. In this preferred embodiment, the pattern-processing circuit 180ij and the peripheral circuits 190ij of the 3D-NVM arrays 170ijA-170ijD are disposed on the substrate 0. They are at least partially covered by the 3D-NVM arrays 170ijA-170ijD. Below the four 3D-NVM arrays 170ijA-170ijD, the pattern-processing circuit 180ij can be laid out. Because it is located under few 3D-NVM arrays 170ijA-170ijD, this preferred pattern-processing circuit 180ij is best for a code-matching circuit, a string-matching circuit, a simple speech-recognition circuit, or a simple image-recognition circuit.

The embodiment of FIG. 5C corresponds to that of FIG. 4C. The 3D-NVM arrays 170ijA-170ijD, 170ijW-170ijZ are divided into two sets: a first set 170ijSA includes four 3D-NVM arrays 170ijA-170ijD, and a second set 170ijSB includes four 3D-NVM arrays 170ijW-170ijZ. Below the four 3D-NVM arrays 170ijA-170ijD of the first set 170ijSA, a first component 180ijA of the pattern-processing circuit 180ij can be laid out. Similarly, below the four 3D-NVM arrays 170ijW-170ijZ of the second set 170ijSB, a second component 180ijB of the pattern-processing circuit 180ij can be laid out. The first and second components 180ijA, 180ijB collectively form the pattern-processing circuit 180ij. In this embodiment, adjacent peripheral circuits 190ij of the 3D-NVM arrays are separated by physical gaps (e.g. G) for forming the routing channel 182, 184, 186, which provide coupling between different components 180ijA, 180ijB, or between different pattern-processing circuits. Because it is located under eight 3D-NVM arrays 170ijA-170ijD and 170ijW-170ijZ, this preferred pattern-processing circuit 180ij can be used for a speech-recognition circuit or an image-recognition circuit.

The preferred pattern processor 100 could be either processor-like or storage-like. The processor-like pattern processor 100 is a 3-D processor with an embedded search-pattern library (or simply, a 3-D processor). It searches a target pattern from the input bus 110 against the embedded search-pattern library. To be more specific, the 3D-NVM array 170 stores at least a portion of the embedded search-pattern library (e.g. a virus library, a keyword library, an acoustic/language model library, an image model library); at least a portion of a target pattern (e.g. a network packet, a digital file, audio data, or image data) is sent to the SPU's 100aa-100mn via the input bus 110; the pattern-processing circuit 180 performs pattern processing. Because massive number of the SPU's 100aa-100mn support massive parallelism while the intra-die connections 160 supports a large bandwidth, the preferred 3-D processor can achieve a high throughput.

Accordingly, the present invention discloses a 3-D processor, comprising a semiconductor substrate having transistors thereon; an input bus for transferring at least a portion of a target pattern; at least one thousand storage-processing units (SPU's) disposed on said semiconductor substrate and communicatively coupled with said input bus, each of said SPU's comprising: a pattern-processing circuit made of single-crystalline semiconductor material, disposed on said semiconductor substrate; at least a 3-D non-volatile memory (3D-NVM) array made of non-single-crystalline semiconductor material, stacked above said pattern-processing circuit; a plurality of intra-die connections for communicatively coupling said 3D-NVM array and said pattern-processing circuit; wherein said 3D-NVM array stores at least a portion of a search pattern; said pattern-processing circuit searches said search pattern in said target pattern.

The storage-like pattern processor is a 3-D memory with in-situ pattern-processing capabilities (or simply, a searchable 3-D memory). Its primary purpose is to store a target-pattern database, with a secondary purpose of searching the stored target-pattern database for a search pattern specified by a user. To be more specific, a target-pattern database (e.g. a collection of digital files, a big-data database/archive, an audio database/archive, an image database/archive) is stored and distributed in the 3D-NVM arrays 170; at least a portion of a search pattern (e.g. a virus signature, a keyword, a model) is sent to the SPU's 100aa-100mn via the input bus 110; the pattern-processing circuit 180 searches the search pattern in the target-pattern database. Because massive number of the SPU's 100aa-100mn support massive parallelism while the intra-die connections 160 supports a large bandwidth, the preferred searchable 3-D memory can achieve a high throughput.

In a preferred searchable 3-D memory die, because each SPU contains a pattern-processing circuit, the data stored in its 3D-NVM array(s) can be individually searched by the local pattern-processing circuit. No matter how large is the capacity of the searchable 3-D memory die, the search time for the whole die is similar to that for a single SPU. Accordingly, most searches can be completed within seconds.

With the 3-D integration, the peripheral circuits of the 3D-NVM arrays and the pattern-processing circuit can be formed on the substrate directly underneath the 3D-NVM arrays. Because the peripheral circuits of the 3D-NVM arrays only occupy a small portion of the substrate area, most substrate area can be used to form the pattern-processing circuits. As the peripheral circuits of the 3D-NVM arrays need to be formed anyway, the pattern-processing circuits can piggyback on the peripheral circuits, i.e. they can be manufactured at the same time with the peripheral circuits. Hence, inclusion of the pattern-processing circuits adds little or no extra cost to the preferred searchable 3-D memory die.

Accordingly, the present invention discloses a searchable 3-D memory, comprising: a semiconductor substrate having transistors thereon; an input bus for transferring at least a portion of a search pattern; a plurality of storage-processing units (SPU's) disposed on said semiconductor substrate and communicatively coupled with said input bus, each of said SPU's comprising: a pattern-processing circuit disposed on said semiconductor substrate; at least a 3-D non-volatile memory (3D-NVM) array stacked above said pattern-processing circuit; a plurality of intra-die connections for communicatively coupling said 3D-NVM array and said pattern-processing circuit; wherein said 3D-NVM array stores at least a portion of a target pattern; said pattern-processing circuit searches said search pattern in said target pattern.

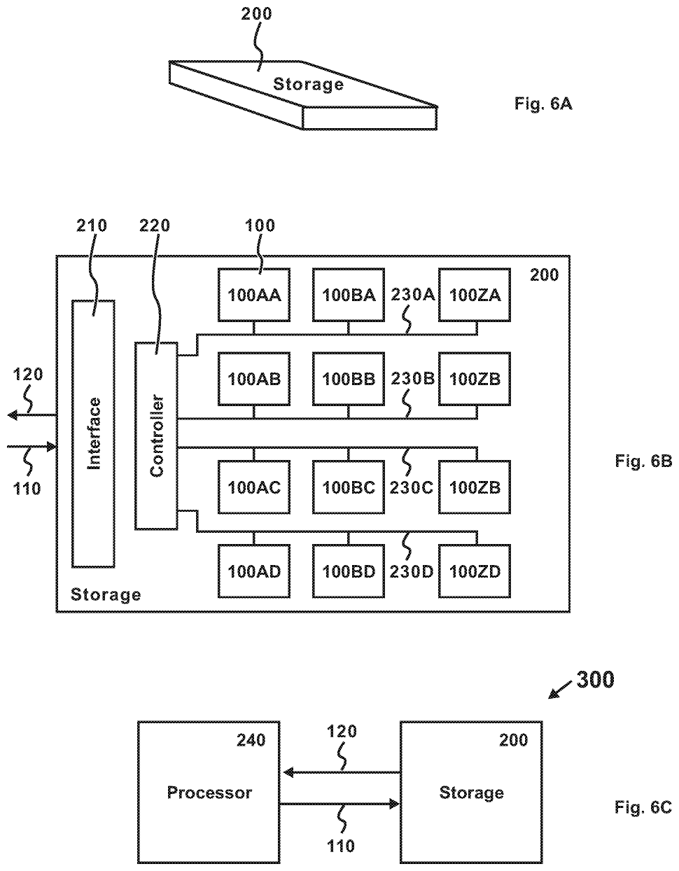

Referring now to FIGS. 6A-6C, a preferred searchable storage and an associated storage system are shown. FIG. 6A is a perspective view of the preferred searchable storage 200. Its external shape is similar to a storage card (e.g. an SD card, a CF card, or a TF card) or a solid-state drive (i.e. SSD). FIG. 6B is a circuit block diagram of the preferred searchable storage 200. It comprises an interface 210, a controller 220 and a plurality of channels 230A-230D. The interface 210 and controller 220 are well known to those skilled in the art. Each channel (e.g. 230A) includes a plurality of the preferred searchable 3-D memory dice 100AA-100ZA. Each of the preferred searchable 3-D memory dice 100AA-100ZD stores at least a portion of data for a target-pattern database. More importantly, all of the searchable 3-D memory dice 100AA-100ZD have in-situ searching capabilities. This is different from the conventional storage, where the flash memory dice are pure memory and do not have any in-situ searching capabilities.

In a searchable 3-D memory die (e.g. 100AA), because each SPU 100ij contains a pattern-processing circuit 180, the data stored in its 3D-NVM array(s) 170 can be individually searched by the local pattern-processing circuit 180. No matter how large is the capacity of the target-pattern database, the search time for the whole database is similar to that for a single SPU 100ij. In other words, the search time for a target-pattern database is irrelevant to its capacity. Most searches can be completed within seconds.

In comparison, for the conventional von Neumann architecture, the processor (e.g. CPU) and the storage (e.g. HDD or SSD) are physically separated. They are communicatively coupled by a system bus. During search, data need to be read out from the storage first. Because of the limited bandwidth of the system bus, the search time for a database is proportional to its capacity. In general, the search time ranges from minutes to hours, even longer, depending on the capacity of the database. Apparently, the preferred searchable storage 200 offers substantial speed advantages in database search.

This speed advantage can be further viewed from the perspective of parallelism. Because each SPU 100ij has its own pattern-processing circuit 180ij, the number of the SPU's grows with the storage capacity, so does the degree of parallelism. As a result, the search time does not increase with the storage capacity. However, for the pattern processor module (Van Lunteren), because the number of the SPU's and the degree of parallelism are fixed, the search time increases with the storage capacity.

Besides a substantial speed advantage, the preferred searchable storage 200 provides a substantial cost advantage. With the 3-D integration, the peripheral circuits (e.g. 190ij) of the 3D-NVM array(s) 170 and the pattern-processing circuit 180 can be formed on the substrate 0 directly underneath the 3D-NVM array(s) 170. Because the peripheral circuits (e.g. 190ij) of the 3D-NVM array(s) 170 only occupy a small portion of the substrate area, most substrate area can be used to form the pattern-processing circuits 180. As the peripheral circuits (e.g. 190ij) of the 3D-NVM arrays 170 need to be formed anyway, the pattern-processing circuits 180 can piggyback on the peripheral circuits (e.g. 190ij), i.e. they can be manufactured at the same time with the peripheral circuits (e.g. 190ij). Hence, inclusion of the pattern-processing circuits 180 adds little or no extra cost to the preferred searchable storage 200. In prior art, inclusion of the pattern-processing circuits require an extra die (e.g. Van Lunteren) or an extra die area, both of which increase cost.

Due to layout constraints, the pattern-processing circuit 180 in the preferred searchable storage 200 has limited functionalities. The preferred searchable storage 200 preferably works with an external processor for full pattern processing. Accordingly, the present invention discloses a storage system 300. FIG. 6C is its circuit block diagram. It comprises a searchable storage 200 and a standalone processor 240 communicatively coupled with a system bus including an input bus 110 and an output bus 120. The standalone processor 240 could be a full-power processor which can perform full pattern processing. It could be a CPU, a GPU, an FPGA, an Al processor, or others. The pattern-processing circuit 180 in the preferred searchable storage 200 performs preliminary pattern processing. After this preliminary pattern-processing step, data are output to the standalone processor 240 to perform full pattern processing. Because the amount of the data output from the preferred searchable storage 200 is substantially smaller than the amount of the data stored in the preferred searchable storage 200, the data transfer places less burden on the output bus 120. With much less data to process, the full pattern processing, even for the full searchable storage 200, takes less time and becomes more efficient.

In the following paragraphs, applications of the preferred pattern processor 100 are described. The fields of applications include: A) information security; B) big-data analytics; C) speech recognition; and D) image recognition. Examples of the applications include: a) information-security processor; b) anti-virus storage; c) data-analysis processor; d) searchable big-data storage; e) speech-recognition processor; f) searchable audio storage; g) image-recognition processor; h) searchable image storage.

A) Information Security

Information security includes network security and computer security. To enhance network security, the network packets needs to be scanned for viruses. Similarly, to enhance computer security, the digital files (including computer files and/or computer software) needs to be scanned for viruses. Generally speaking, virus (also known as malware) includes network viruses, computer viruses, software that violates network rules, document that violates document rules and others. During virus scan, a network packet or a digital file is compared against the virus patterns (including virus signatures, network rules, document rules, and others) in a virus library. Once a match is found, the portion of the network packet or the digital file which contains the virus is quarantined or removed.

Nowadays, the virus library has become large. It has reached hundreds of megabytes and is still growing. On the other hand, the data that require virus scan are even larger, typically on the order of gigabytes to terabytes, or even bigger. On the other hand, each processor core in the conventional processor can typically check a single virus pattern once. With a limited number of cores (e.g. tens to hundreds), the conventional processor can achieve limited parallelism for virus scan. Furthermore, because the processor is physically separated from the storage in the von Neumann architecture, it takes a long time to fetch new virus patterns. As a result, the conventional processor and its associated architecture have a poor performance for information security.

To enhance information security, the present invention discloses an information-security processor (i.e. a processor for enhancing information security), as well as an anti-virus storage (i.e. a storage with in-situ virus-scanning capabilities).

a) Information-Security Processor

To enhance information security, the present invention discloses an information-security processor 100. It is a monolithic die and searches a network packet or a digital file for various virus patterns in a virus library. If there is a match with a virus pattern, the network packet or the digital file is considered being infected by the virus. The preferred information-security processor 100 can be installed as a standalone processor in a network or a computer; or, integrated into a network processor, a computer processor, or a computer storage.

In the preferred information-security processor 100, the 3D-NVM arrays 170 in different SPU 100ij store different virus patterns. In other words, the virus library is stored and distributed in the SPU's 100aa-100mn of the preferred information-security processor 100. Once a network packet or a digital file is received on the input bus 110, at least a portion thereof is sent to the SPU's 100aa-100mn. In each SPU 100ij, the pattern-processing circuit 180 compares said portion of the network packet or the digital file against the virus patterns stored in the local 3D-NVM array 170.

The above virus-scan operations are carried out by the SPU's 100aa-100mn at the same time. Because it comprises massive number of SPU's 100aa-100mn (thousands to tens of thousands, or even more), the preferred information-security processor 100 achieves massive parallelism for virus scan. Furthermore, because the intra-die connections 160 are numerous and the pattern-processing circuit 180 is physically close to the 3D-NVM arrays 170 (compared with the conventional von Neumann architecture), the pattern-processing circuit 180 can easily fetch new virus patterns from the local 3D-NVM array 170. As a result, the preferred information-security processor 100 can perform fast and efficient virus scan. In this preferred embodiment, the 3D-NVM arrays 170 storing the virus library could be 3D-P, 3D-OTP or 3D-MTP; and, the pattern-processing circuit 180 is a code-matching circuit.

Accordingly, the present invention discloses a monolithic information-security processor, comprising a semiconductor substrate having transistors thereon; an input bus for transferring at least a portion of data from a network packet or a digital file; at least one thousand storage-processing units (SPU's) disposed on said semiconductor substrate and communicatively coupled with said input bus, each of said SPU's comprising: a code-matching circuit disposed on said semiconductor substrate; at least a 3-D non-volatile memory (3D-NVM) array stacked above said code-matching circuit; a plurality of intra-die connections for communicatively coupling said 3D-NVM array and said code-matching circuit; wherein said 3D-NVM array stores at least a portion of a virus pattern; said code-matching circuit searches said virus pattern in said portion of data. Preferably, the number of SPU's in said information-security processor is substantially more than the number of SPU's in a pattern processor module.

b) Anti-Virus Storage

Whenever a new virus is discovered, the whole storage (e.g. a hard-disk drive, a solid-state drive) of the computer needs to be scanned against the new virus. This full-storage scan process is challenging to the conventional von Neumann architecture. It takes a long time to even read out all data, let alone scan virus for them. For the conventional von Neumann architecture, the full-storage scan time is proportional to the total capacity of the storage.

To shorten the full-storage scan time, the present invention discloses an anti-virus storage. It is a searchable storage 200, which has in-situ virus-scanning capabilities. To be more specific, its primary function is a storage, with in-situ virus-scanning capabilities as its secondary function. Like the flash memory dice in an SSD, a large number of the preferred searchable 3-D memory dice 100 can be packaged into the preferred anti-virus storage 200 (e.g. an anti-virus storage card or an anti-virus solid-state drive).

In each searchable 3-D memory dice 100 of the preferred anti-virus storage 200, the 3D-NVM arrays 170 in different SPU's 100aa-100mn store different portions of the digital files. In other words, digital files are stored and distributed in the SPU's 100aa-100mn of the searchable 3-D memory dice 100 in the preferred anti-virus storage 200. Once a new virus is discovered and a full-storage scan is required, the virus pattern of the new virus is sent via the input bus 110 to the SPU's 100aa-100mn, where the pattern-processing circuit 180 compares the data stored in the local 3D-NVM array 170 against the virus pattern.

The above virus-scan operations are carried out by the SPU's 100aa-100mn at the same time. Because of the massive parallelism, no matter how large is the capacity of the preferred anti-virus storage 200, the virus-scan time for the whole storage 200 is more or less a constant, which is close to the virus-scan time for a single SPU 100ij and generally within seconds. On the other hand, the conventional full-storage scan takes minutes to hours, or even longer. In this preferred embodiment, the 3D-NVM arrays 170 are preferably 3D-MTP; and, the pattern-processing circuit 180 is a code-matching circuit.

Accordingly, the present invention discloses an anti-virus storage, comprising a plurality of searchable 3-D memory dice, each of said searchable 3-D memory dice comprising: a semiconductor substrate having transistors thereon; an input bus for transferring at least a portion of virus pattern; a plurality of storage-processing units (SPU's) disposed on said semiconductor substrate and communicatively coupled with said input bus, each of said SPU's comprising: a code-matching circuit disposed on said semiconductor substrate; at least a 3-D non-volatile memory (3D-NVM) array stacked above said code-matching circuit; a plurality of intra-die connections for communicatively coupling said 3D-NVM array and said code-matching circuit; wherein said 3D-NVM array stores at least a portion of data; said code-matching circuit searches said virus pattern in said portion of data.

B) Big-Data Analytics

Big data is a term for a large collection of data, with main focus on unstructured and semi-structure data. An important aspect of big-data analytics is keyword search (including string matching, e.g. regular-expression matching). At present, the keyword library becomes large, while the big-data database is even larger. For such large keyword library and big-data database, the conventional processor and its associated architecture can hardly perform fast and efficient keyword search on unstructured or semi-structured data.

To improve the speed and efficiency of big-data analytics, the present invention discloses a data-analysis processor (i.e. a processor for performing analysis on big data), as well as a searchable storage (i.e. a storage supporting in-situ search).

c) Data-Analysis Processor

To perform fast and efficient search on big data, the present invention discloses a data-analysis processor 100. It is a monolithic die and searches the input data for the keywords from a keyword library. In the preferred data-analysis processor 100, the 3D-NVM arrays 170 in different SPU's 100aa-100mn store different keywords. In other words, the keyword library is stored and distributed in the SPU's 100aa-100mn of the preferred data-analysis processor 100. Once data are received via the input bus 110, at least a portion thereof is sent to the SPU's 100aa-100mn. In each SPU 100ij, the pattern-processing circuit 180 compares said portion of data against various keywords stored in the local 3D-NVM array 170.

The above search operations are carried out by the SPU's 100aa-100mn at the same time. Because it comprises massive number of SPU's 100aa-100mn (thousands to tens of thousands or even more), the preferred data-analysis processor 100 achieves massive parallelism for keyword search. Furthermore, because the intra-die connections 160 are numerous and the pattern-processing circuit 180 is physically close to the 3D-NVM arrays 170 (compared with the conventional von Neumann architecture), the pattern-processing circuit 180 can easily fetch keywords from the local 3D-NVM array 170. As a result, the preferred data-analysis processor 100 can perform fast and efficient search on unstructured data or semi-structured data. In this preferred embodiment, the 3D-NVM arrays 170 storing the keyword library could be 3D-P, 3D-OTP or 3D-MTP; and, the pattern-processing circuit 180 is a string-matching circuit.

Accordingly, the present invention discloses a monolithic data-analysis processor, comprising a semiconductor substrate having transistors thereon; an input bus for transferring at least a portion of data; at least one thousand storage-processing units (SPU's) disposed on said semiconductor substrate and communicatively coupled with said input bus, each of said SPU's comprising: a string-matching circuit disposed on said semiconductor substrate; at least a 3-D non-volatile memory (3D-NVM) array stacked above said string-matching circuit; a plurality of intra-die connections for communicatively coupling said 3D-NVM array and said string-matching circuit; wherein said 3D-NVM array stores at least a portion of a keyword; said string-matching circuit searches said keyword in said portion of data. Preferably, the number of SPU's in said data-analysis processor is substantially more than the number of SPU's in a pattern processor module.

d) Searchable Big-Data Storage

Big-data analytics often requires full-database search, e.g. to search a whole database for a keyword. The full-database search is challenging to the conventional von Neumann architecture. Because the database is large, with a capacity of gigabytes to terabytes, or even larger, it takes a long time to even read out all data, let alone analyze them. For the conventional von Neumann architecture, the full-database search time is proportional to the database size.

To improve the overall performance of full-database search, the present invention discloses a searchable big-data storage 200. It is a searchable storage 200, which has in-situ big-data analyzing capabilities. Its primary function is storage, with in-situ big-data analyzing (e.g. searching) capabilities as its secondary function. Like the flash memory in an SSD, a large number of the preferred searchable 3-D memory dice 100 can be packaged into the preferred searchable big-data storage 200.

In the searchable 3-D memory dice 100 of the preferred searchable big-data storage 200, the 3D-NVM arrays 170 in different SPU's 100aa-100mn store different portions of the database. In other words, the database is stored and distributed in the SPU's 100aa-100mn of the searchable 3-D memory dice 100 in the preferred searchable big-data storage 200. During search, a keyword is sent via the input bus 110 to the SPU's 100aa-100mn. In each SPU 100ij, the pattern-processing circuit 180 searches the portion of the database stored in the local 3D-NVM array 170 for the keyword.

The above search operations are carried out by the SPU's 100aa-100mn at the same time. Because of massive parallelism, no matter how large is the capacity of the searchable big-data storage 200, the keyword-search time for the whole storage 200 is more or less a constant, which is close to the keyword-search time for a single SPU 100ij and generally within seconds. On the other hand, the conventional full-storage search takes minutes to hours, or even longer. In this preferred embodiment, the 3D-NVM arrays 170 are preferably 3D-MTP; and, the pattern-processing circuit 100 is a string-matching circuit.

Having the largest storage density among all semiconductor memories, the 3D-NVM_{V} is particularly suitable for storing a big-data database. Among all 3D-NVM_{V}, the 3D-OTP_{V} has a long data lifetime (e.g. >100 years) and therefore, is particularly suitable for archiving. Because archives store massive data, fast searchability is very important. A searchable 3D-OTP_{V} will provide a large, inexpensive archive with fast searching capabilities.

Accordingly, the present invention discloses a searchable big-data storage comprising a plurality of searchable 3-D memory dice, each of said searchable 3-D memory dice comprising: a semiconductor substrate having transistors thereon; an input bus for transferring at least a portion of a keyword; a plurality of storage-processing units (SPU's) disposed on said semiconductor substrate and communicatively coupled with said input bus, each of said SPU's comprising: a string-matching circuit disposed on said semiconductor substrate; at least a 3-D non-volatile memory (3D-NVM) array stacked above said string-matching circuit; a plurality of intra-die connections for communicatively coupling said 3D-NVM array and said string-matching circuit; wherein said 3D-NVM array stores at least a portion of data; said string-matching circuit searches said keyword in said portion of data.

C) Speech Recognition

Speech recognition enables the recognition and translation of spoken language. It is primarily implemented through pattern recognition on the audio data with an acoustic/language model, which is a part of an acoustic/language model library. During speech recognition, the pattern-processing circuit 180 performs speech recognition on the audio data by finding the nearest acoustic/language model in the acoustic/language model library. Because the conventional processor (e.g. CPU, GPU, FPGA) has a limited number of cores and the acoustic/language model database is stored externally, the conventional processor and the associated architecture have a poor performance in speech recognition.

e) Speech-Recognition Processor

To improve the performance of speech recognition, the present invention discloses a speech-recognition processor 100. It is a monolithic die and performs speech recognition on the audio data using the acoustic/language models stored in a local acoustic/language library. To be more specific, the audio data is sent via the input bus 110 to the SPU's 100aa-100mn. The 3D-NVM arrays 170 store at least a portion of the acoustic/language model. In other words, an acoustic/language model library is stored and distributed in the SPU's 100aa-100mn of the preferred speech-recognition processor 100. In this preferred embodiment, the 3D-NVM arrays 170 storing the models could be 3D-P, 3D-OTP, or 3D-MTP; and, the pattern-processing circuit 180 is a speech-recognition circuit.

Accordingly, the present invention discloses a monolithic speech-recognition processor, comprising: a semiconductor substrate having transistors thereon; an input bus for transferring at least a portion of audio data; at least one thousand storage-processing units (SPU's) disposed on said semiconductor substrate and communicatively coupled with said input bus, each of said SPU's comprising: a speech-recognition circuit disposed on said semiconductor substrate; at least a 3-D non-volatile memory (3D-NVM) array stacked above said speech-recognition circuit; a plurality of intra-die connections for communicatively coupling said 3D-NVM array and said speech-recognition circuit; wherein said 3D-NVM array stores at least a portion of an acoustic/language model; said speech-recognition circuit performs speech recognition on said portion of audio data with said acoustic/language model. Preferably, the number of SPU's in said speech-recognition processor is substantially more than the number of SPU's in a pattern processor module.

f) Searchable Audio Storage

To enable audio search in an audio database (e.g. an audio archive), the present invention discloses a searchable audio storage. It comprises a plurality of searchable 3-D memory dice. An acoustic/language model derived from the audio data to be searched for is sent via the input bus 110 to the SPU's 100aa-100mn of each of the preferred searchable 3-D memory dice. The 3D-NVM array(s) 170 of each of the preferred searchable 3-D memory dice stores at least a portion of the audio database/archive. In other words, the audio database is stored and distributed in the SPU's 100aa-100mn of the preferred searchable audio storage. The pattern-processing circuit 180 performs speech recognition on the audio data stored in the 3D-NVM arrays 170 with the acoustic/language model from the input bus 110. In this preferred embodiment, the 3D-NVM arrays 170 storing the audio database are preferably 3D-MTP; and, the pattern-processing circuit 180 is a speech-recognition circuit.

Accordingly, the present invention discloses a searchable audio storage comprising a plurality of searchable 3-D memory dice, each of said searchable 3-D memory dice comprising: a semiconductor substrate having transistors thereon; an input bus for transferring at least a portion of an acoustic/language model; a plurality of storage-processing units (SPU's) disposed on said semiconductor substrate and communicatively coupled with said input bus, each of said SPU's comprising: a speech-recognition circuit disposed on said semiconductor substrate; at least a 3-D non-volatile memory (3D-NVM) array stacked above said speech-recognition circuit; a plurality of intra-die connections for communicatively coupling said 3D-NVM array and said speech-recognition circuit; wherein said 3D-NVM array stores at least a portion of audio data; said speech-recognition circuit performs speech recognition on said portion of audio data with said acoustic/language model.

D) Image Recognition

Image recognition enables the recognition of images. It is primarily implemented through pattern recognition on image data with an image model, which is a part of an image model library. During image recognition, the pattern-processing circuit 180 performs image recognition on the image data by finding the nearest image model in the image model library. Because the conventional processor (e.g. CPU, GPU, FPGA) has a limited number of cores and the image model database is stored externally, the conventional processor and the associated architecture have a poor performance in image recognition.

g) Image-Recognition Processor

To improve the performance of image recognition, the present invention discloses an image-recognition processor 100. It is a monolithic die and performs image recognition on the image data using the image models stored in a local image library. To be more specific, the image data is sent via the input bus 110 to the SPU's 100aa-100mn. The 3D-NVM arrays 170 store at least a portion of the image model. In other words, an image model library is stored and distributed in the SPU's 100aa-100mn. In this preferred embodiment, the 3D-NVM arrays 170 storing the models could be 3D-P, 3D-OTP, or 3D-MTP; and, the pattern-processing circuit 180 is an image-recognition circuit.

Accordingly, the present invention discloses a monolithic image-recognition processor, comprising a semiconductor substrate having transistors thereon; an input bus for transferring at least a portion of image data; at least one thousand storage-processing units (SPU's) disposed on said semiconductor substrate and communicatively coupled with said input bus, each of said SPU's comprising: an image-recognition circuit disposed on said semiconductor substrate; at least a 3-D non-volatile memory (3D-NVM) array stacked above said image-recognition circuit; a plurality of intra-die connections for communicatively coupling said 3D-NVM array and said image-recognition circuit; wherein said 3D-NVM array stores at least a portion of an image model; said image-recognition circuit performs image recognition on said portion of image data with said image model. Preferably, the number of SPU's in said image-recognition processor is substantially more than the number of SPU's in a pattern processor module.

h) Searchable Image Storage

To enable image search in an image database (e.g. an image archive), the present invention discloses a searchable image storage. It comprises a plurality of searchable 3-D memory dice. An image model derived from the image data to be searched for is sent via the input bus 110 to the SPU's 100aa-100mn of each of the preferred searchable 3-D memory dice. The 3D-NVM array(s) 170 of each of the preferred searchable 3-D memory dice stores at least a portion of the image database/archive. In other words, the image database is stored and distributed in the SPU's 100aa-100mn of the preferred searchable image storage. The pattern-processing circuit 180 performs image recognition on the image data stored in the 3D-NVM arrays 170 with the image model from the input bus 110. In this preferred embodiment, the 3D-NVM arrays 170 storing the image database are preferably 3D-MTP; and, the pattern-processing circuit 180 is an image-recognition circuit.

Accordingly, the present invention discloses a searchable image storage comprising a plurality of searchable 3-D memory dice, each of said searchable 3-D memory dice comprising: a semiconductor substrate having transistors thereon; an input bus for transferring at least a portion of an image model; a plurality of storage-processing units (SPU's) disposed on said semiconductor substrate and communicatively coupled with said input bus, each of said SPU's comprising: an image-recognition circuit disposed on said semiconductor substrate; at least a 3-D non-volatile memory (3D-NVM) array stacked above said image-recognition circuit; a plurality of intra-die connections for communicatively coupling said 3D-NVM array and said image-recognition circuit; wherein said 3D-NVM array stores at least a portion of image data; said image-recognition circuit performs image recognition on said portion of image data with said image model.

While illustrative embodiments have been shown and described, it would be apparent to those skilled in the art that many more modifications than that have been mentioned above are possible without departing from the inventive concepts set forth therein. The invention, therefore, is not to be limited except in the spirit of the appended claims.

1-20. (canceled)

21. A searchable storage comprising a plurality of searchable 3-D memory dice, each of said searchable 3-D memory dice comprising: a single semiconductor substrate; an input bus for transferring at least a search pattern; a plurality of storage-processing units (SPU's) communicatively coupled with said input bus, wherein each of said SPU's comprises:
at least a 3-D non-volatile memory (3D-NVM) array including memory cells above said semiconductor substrate and storing at least a portion of data;
a pattern-processing circuit on said semiconductor substrate for performing pattern processing for said search pattern and said portion of data;
a plurality of intra-die connections for communicatively coupling said 3D-NVM array and said pattern-processing circuit;
whereby the primary purpose of said searchable storage is long-term storage and the secondary purpose of said searchable storage is in-situ search.

22. The searchable storage according to claim 21, wherein said semiconductor substrate comprises at least a single-crystalline semiconductor material; and, said memory cells do not comprise any single-crystalline semiconductor material.

23. The searchable storage according to claim 21, wherein said plurality of SPU's include more than one thousand SPU's; or, said intra-die connections include contact vias through no semiconductor substrate.

24. The searchable storage according to claim 21, wherein said 3D-NVM array is a vertical 3D-NVM or a horizontal 3D-NVM.

25. The searchable storage according to claim 21 being an anti-virus storage, wherein
said input bus transfers at least a portion of a virus pattern;
said 3D-NVM array stores at least a portion of data;
said pattern-processing circuit is a code-matching circuit for searching said virus pattern in said portion of data.

26. The searchable storage according to claim 21 being a searchable big-data storage, wherein
said input bus transfers at least a portion of a keyword;
said 3D-NVM array stores at least a portion of data;
said pattern-processing circuit is a string-matching circuit for searching said keyword in said portion of data.

27. The searchable storage according to claim 21 being a searchable audio storage, wherein
said input bus transfers at least a portion of an acoustic/language model;
said 3D-NVM array stores at least a portion of audio data;
said pattern-processing circuit is a speech-recognition circuit for performing speech recognition on said portion of audio data with said acoustic/language model.

28. The searchable storage according to claim 21 being a searchable image storage, wherein
said input bus transfers at least a portion of an image model;
said 3D-NVM array stores at least a portion of image data;
said pattern-processing circuit is an image-recognition circuit for performing image recognition on said portion of image data with said image model.

29. The searchable storage according to claim 21, wherein full pattern processing on at least a fraction of said portion of data is performed by a standalone processor separate from said searchable storage.

30. A pattern processor die, comprising a semiconductor substrate; an input bus for transferring at least a first portion of a first pattern; a plurality of storage-processing units (SPU's) communicatively coupled with said input bus, each of said SPU's comprising:
at least a 3-D non-volatile memory (3D-NVM) array including memory cells above said semiconductor substrate and storing at least a second portion of a second pattern;
a pattern-processing circuit on said semiconductor substrate for performing pattern processing for said first and second patterns;
a plurality of intra-die connections for communicatively coupling said 3D-NVM array and said pattern-processing circuit;
wherein said semiconductor substrate comprises at least a single-crystalline semiconductor material; and, said memory cells do not comprise any single-crystalline semiconductor material.

31. The pattern processor die according to claim 30, wherein: said plurality of SPU's include more than one thousand SPU's; or, said intra-die connections include contact vias through no semiconductor substrate.

32. The pattern processor die according to claim 30, wherein said 3D-NVM array is a vertical 3D-NVM or a horizontal 3D-NVM.

33. The pattern processor die according to claim 30, wherein
said input bus transfers at least a portion of a network packet or a digital file;
said 3D-NVM array stores at least a portion of a virus pattern;
said pattern-processing circuit is a code-matching circuit for searching said virus pattern in said portion of said network packet or said digital file.

34. The pattern processor die according to claim 30, wherein
said input bus transfers at least a portion of data;
said 3D-NVM array stores at least a portion of a keyword;
said pattern-processing circuit is a string-matching circuit for searching said keyword in said portion of data.

35. The pattern processor die according to claim 30, wherein
said input bus transfers at least a portion of audio data;
said 3D-NVM array stores at least a portion of an acoustic/language model;
said pattern-processing circuit is a speech-recognition circuit for performing speech recognition on said portion of audio data with said acoustic/language model.

36. The pattern processor die according to claim 30, wherein
said input bus transfers at least a portion of image data;
said 3D-NVM array stores at least a portion of an image model;
said pattern-processing circuit is an image-recognition circuit for performing image recognition on said portion of image data with said image model.

37. The pattern processor die according to claim 30, wherein
said input bus transfers at least a portion of a virus pattern;
said 3D-NVM array stores at least a portion of data;
said pattern-processing circuit is a code-matching circuit for searching said virus pattern in said portion of data.

38. The pattern processor die according to claim 30, wherein
said input bus transfers at least a portion of a keyword;
said 3D-NVM array stores at least a portion of data;
said pattern-processing circuit is a string-matching circuit for searching said keyword in said portion of data.

39. The pattern processor die according to claim 30, wherein
said input bus transfers at least a portion of an acoustic/language model;
said 3D-NVM array stores at least a portion of audio data;
said pattern-processing circuit is a speech-recognition circuit for performing speech recognition on said portion of audio data with said acoustic/language model.

40. The pattern processor die according to claim 30, wherein
said input bus transfers at least a portion of an image model;
said 3D-NVM array stores at least a portion of image data;
said pattern-processing circuit is an image-recognition circuit for performing image recognition on said portion of image data with said image model.
